(19) United States
(12) Patent Application Publication
(10) Pub. No.: US 2013/0239497 A1
(43) Pub. Date: Sep. 19, 2013

(54) SYSTEM FOR PROTECTING OPENINGS ON BUILDING STRUCTURES

(71) Applicants: Raymond Burleson, Oak Island, NC (US); Shirley Burleson, Oak Island, NC (US)

(72) Inventors: Raymond Burleson, Oak Island, NC (US); Shirley Burleson, Oak Island, NC (US)

(21) Appl. No.: 13/845,212

(22) Filed: Mar. 18, 2013

Related U.S. Application Data
(60) Provisional application No. 61/612,891, filed on Mar. 19, 2012.

(51) Int. Cl. E06B 9/02; E06B 1/00

(52) U.S. Cl. CPC E06B 9/02; E06B 1/00
USPC 52/203; 52/204.1; 52/741.3

(57) ABSTRACT

A system for protecting openings on building structures includes a pair of substantially triangular securing devices; at least one bracket; and a protective panel. The securing devices are semi-permanently attached at the upper corners adjacent a building opening, and releaseably receive the corners of the protective panel. The bracket supports the bottom edge of the protective panel. In one embodiment the securing devices and bottom support structure are unitarily formed with a window, thereby being an improved window with integrated components that facilitate easy and fast protection.

### CROSS-REFERENCE TO A RELATED APPLICATION

This application claims the benefit of provisional patent application 61/612,891, which was filed on Mar. 19, 2012.

### BACKGROUND OF THE INVENTION

The present invention relates to the protection of openings on building structures, and more specifically, to a system for quickly covering fragile areas such as windows, window openings, doors and door openings, using a pair of substantially permanently mounted triangular securing devices for receiving the upper corners of panel such as plywood, and at least one bracket for stabilizing the bottom edge of that panel.

There are many times when it is desirable to cover fragile areas such as intact windows, windowless openings, doors and doorless openings on building structures. Examples of such times include before a hurricane, when a building will be unoccupied for a long duration, during times of civil unrest, to prevent theft or vandalism, during the construction process and when undergoing repairs. However, “boarding up” windows and doors is a cumbersome job that typically requires several people to perform. More specifically, one person typically maintains the covering substrate such as plywood against the structure, while the other person secures the covering substrate to the underlying building.

In addition to being time and labor intensive, conventional boarding methods leave many holes in the underlying structure. Alternatively, there are various devices on the market for shuttering and covering, but these are expensive, unattractive, complicated to use, and/or damage the underlying structure.

As can be seen, there is a need for a system for protecting openings on structures that is easy to install, semi-permanent, inexpensive and inflicts minimal damage to the underlying structure.

### SUMMARY

The present inventions pertain to systems and methods associated with protecting fragile areas on building structures. Fragile areas can include windows, window opening, doors, door openings, damaged areas, artwork, or any other area that is desirably covered.

The system desirably includes a pair of substantially triangular securing devices that have a hollow interior, and a bottom bracket. The securing devices are semi-permanently attached at the upper corners of the fragile area, for example adjacent the left and right upper corners of a window, with the hollow interior oriented downwardly. The bracket is semi-permanently attached to the bottom edge of the fragile area, for example centered adjacent the bottom of a window. The securing devices and bracket are desirably left in position, even when not in use, so as to be available when needed. To protect a fragile area, one inserts the upper corners of a panel into the securing devices, and brings the bottom edge of the panel to rest, and/or engage with, the bracket.

The system includes an embodiment wherein the securing devices and bracket (in the form of a ledge) are unitarily formed with a window, thereby creating an improved window having integrated accessories for rapid protection. This design preferably includes a pair of opposing orifices defined by the lateral sides of the window, which are configured to receive terminal ends of a brace. In this manner a panel is secured over a fragile area, and a brace is used to hold the panel in position.

The system also includes the method of using the various structures, including securing devices, brackets, panels, orifices, braces and so forth.

### BRIEF DESCRIPTION OF THE DRAWINGS

FIG. 1 is a perspective view of a securing device embodiment;

FIG. 2 is a top view of a securing device embodiment;

FIG. 3 is a bottom view of a securing device embodiment;

FIG. 4 is a side view of a securing device embodiment, looking inward;

FIG. 5 is a top view of a securing device embodiment having apertures;

FIG. 6 is a perspective view of a bracket embodiment;

FIG. 7 depicts one embodiment of the invention, with 7A being a conventional window, 7B being a conventional window with a pair of securing devices attached above and a bracket attached below, 7C showing the insertion of a panel into the pair of securing devices, 7D showing the panel in position before lowering, and 7E showing the lowered panel;

FIG. 8 shows one embodiment of the panel in place;

FIG. 9 depicts an integrated window embodiment; and

FIG. 10 depicts an integrated window embodiment with panel in place.

### DETAILED DESCRIPTION OF THE INVENTION

The following detailed description is of the best currently contemplated modes of carrying out exemplary embodiments of the invention. The description is made merely for the purpose of illustrating the general principles of the invention, and should not be construed as limiting the invention.

It should be understood that “openings” is used generically herein and, unless otherwise specified, pertains to windows, window frames, doors, doorways, and to other structural openings that may include underlying features to be protected such as window glass, doors and building interiors.

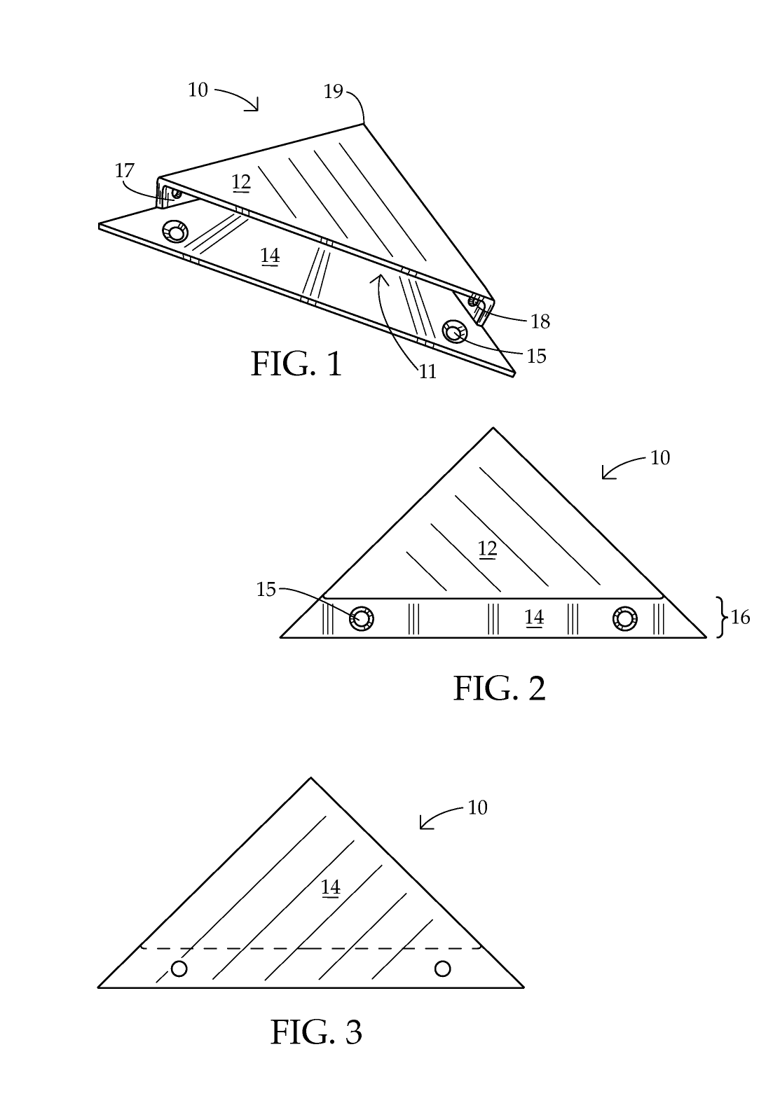

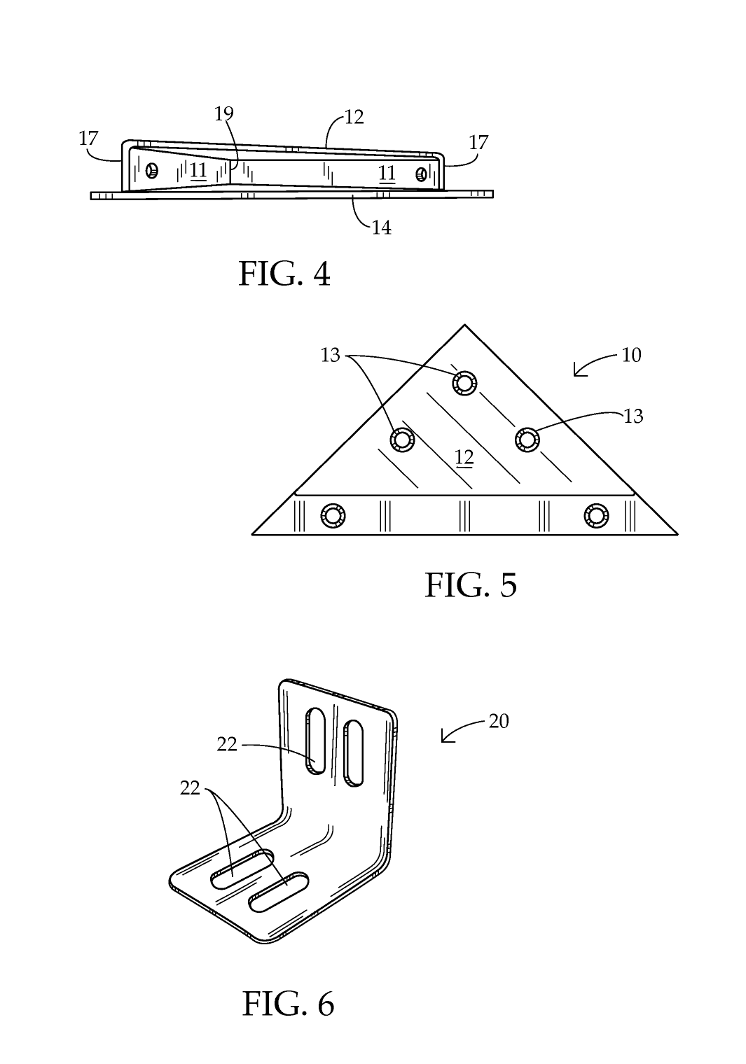

Referring to FIG. 1, securing device 10 generally includes triangular and planar top surface 12, connected along two sides of the triangle by walls 17 to bottom surface 14, forming interior hollow region 11. Top surface 12 has a slightly smaller apex 19 to base length compared to bottom surface 14, thereby forming overhang 16, best shown in FIG. 2. The base of top surface 12 is shown in phantom in FIG. 3. Bottom surface 14 includes at least two bottom surface screw holes 15, and walls 17 each preferably including at least one wall screw hole 18. FIG. 4 depicts a side view of the device, looking into hollow region 11, with walls 17 coming together at apex 19. As described later, securing device 10 is preferably used for securing the upper corners of a panel over an opening.

The approximate (+/−10%) preferred dimensions (in degrees or inches) of securing device 10 and bracket 20 are as follows:
Apex angle of 90°
Top surface 12 length of apex 19 to base—2¼″ to 2¾″, with 2¾″ preferred
Top surface 12 length of two sides adjacent to apex—3″ to 4″ with 4″ preferred
Top surface 12 length of base side—5″ to 6″ with 6″ preferred
Bottom surface 14 length of apex 19 to base—3″ to 3½″, with 3½″ preferred
Bottom surface 14 length of two sides adjacent to apex—4″ to 5″ with 5″ preferred
Bottom surface 14 length of base side—6″ to 7″ with 7″ preferred
Vertical clearance of hollow region 11—⅝″ to 1″ with ⅞″ preferred
Thickness of material—⅛″ if stainless steel, 3/16″ to ¼″ if fiberglass
Apertures 13 set in 1″ from overhang 16 corner
Wall screw holes 18 set in ¾″ from edge of wall 17
Bracket 20 length of long portion of “L”—1½″
Bracket 20 length of short portion of “L”—1″
Bracket 20 width—2¼″

Preferably securing device 10 is constructed of fiberglass, injected molded plastic, wood, wood composites, marine plywood, stainless steel, aluminum or steel.

FIG. 5 shows another embodiment of the present invention wherein apertures 13 are defined by top surface 12. Functionally these apertures provide structural integrity to the planar surface, as well as providing access to a panel that is subsequently inserted for purposes of securing that panel, for example by screws.

FIG. 6 is bracket 20, which is preferably an L-shaped bracket including bracket screw holes 22. As described later, bracket 20 is preferably used for securing the bottom edge of a panel which is positioned over an opening.

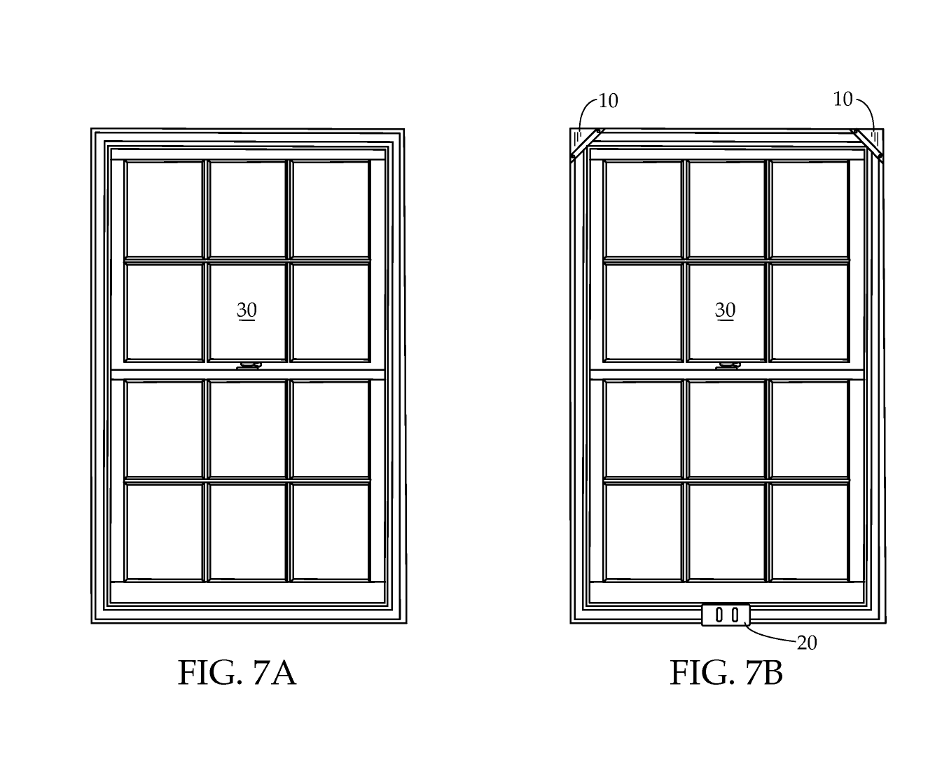

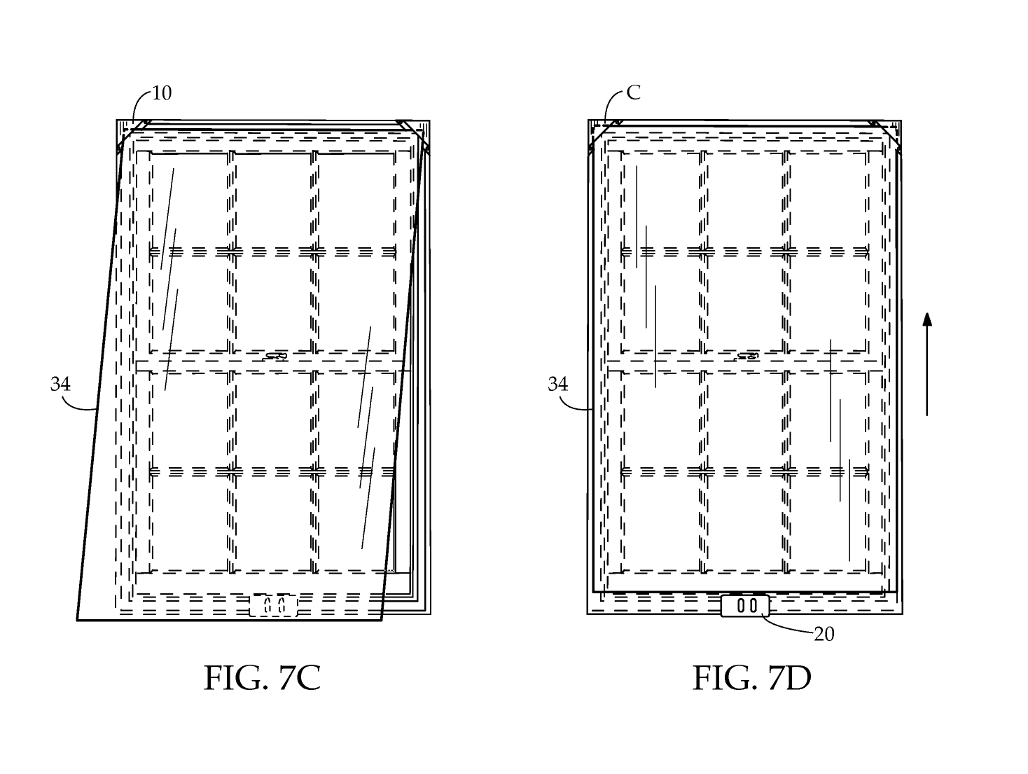

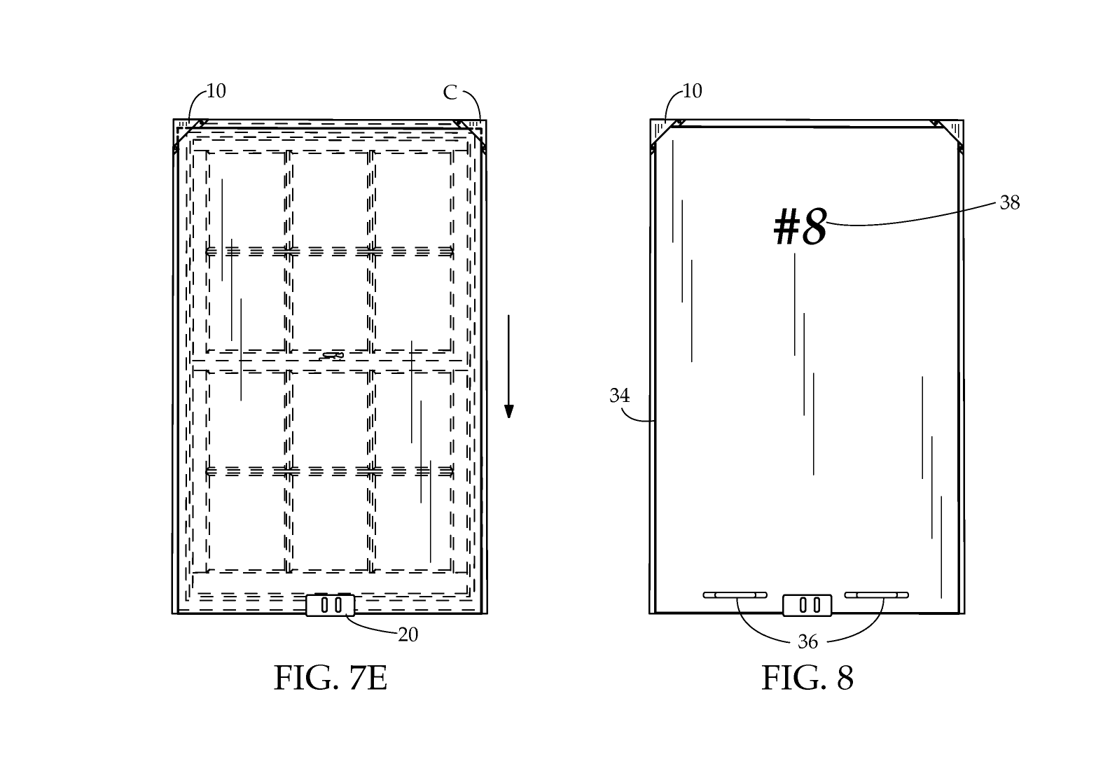

The various views of FIG. 7 depict one method of using the device. FIG. 7A is a conventional opening, such as window 30. In FIG. 7B, a pair of securing devices 10 are substantially permanently attached above the upper corners of window 30. If the window is recessed (ie there is an edge perimeter, commonly made of wood or other molding) it may be desirable to use wall screw holes 18 so securing device 10 is attached within the opening. Alternatively, if there is no frame and the window is more or less flush, it may be desirable to employ bottom surface screw holes 15 to attach securing device 10 directly to the underlying surface, ie the building structure or molding. Securing devices 10 are preferably spaced so as to subsequently receive a protective panel, such as plywood, that is large enough to cover the opening with at least several inches overlap around the perimeter covering the underlying surface.

Bracket 20 is substantially permanently attached below window 30. The preferred resulting orientation is that the short section of the “L” is parallel to the underlying structure, with the angle downward, thereby forming a lip to receive panel 34. The long section of the “L” is preferably positioned and secured to the structure itself, either on the window sill (if recessed window) or underside of window sill (if window is more or less flush with structure). Substantial permanent attachment of securing devices 10 and bracket 20 can be by screws or other hardware and methods so long as securing device 10 and bracket 20 are connected strongly enough that they remain in position during use and between uses. Preferably, however, securing devices 10 and bracket 20 can be removed if desired, without inflicting substantial damage to the underlying structure.

As depicted in FIG. 7C, the upper corners of panel 34 are inserted into securing devices 10, while the bottom edge of panel 35 tilts outward. Panel 34 can be a variety of materials such as plywood, particle board, plastic, or metal, but is preferably durable and weather resistant. While the length and width of the panel can be a variety of sizes, depending on the dimension of the opening to be protected, the thickness of the panel is preferably approximately ¼″ to ¾″ inches, as this is capable of moving freely within hollow region 11 during installation, yet is reasonably secure in the X-, Y- and Z-directions upon installation. As shown in FIG. 7D, bottom edge of panel 34 is moved towards structure and raised, so there is little clearance “C” between upper corners of panel 34 and walls 17 of securing device 10. Finally, as shown in FIG. 7E, panel 34 is lowered so bottom edge rests on bracket 20. Clearance “C” is now greater than it was in FIG. 7D, but panel 34 is still held securely. Panel 34 is secured to bracket 20 by screws through bracket screw holes 22. Optionally, panel 34 can also be secured through apertures 13 in securing device 10.

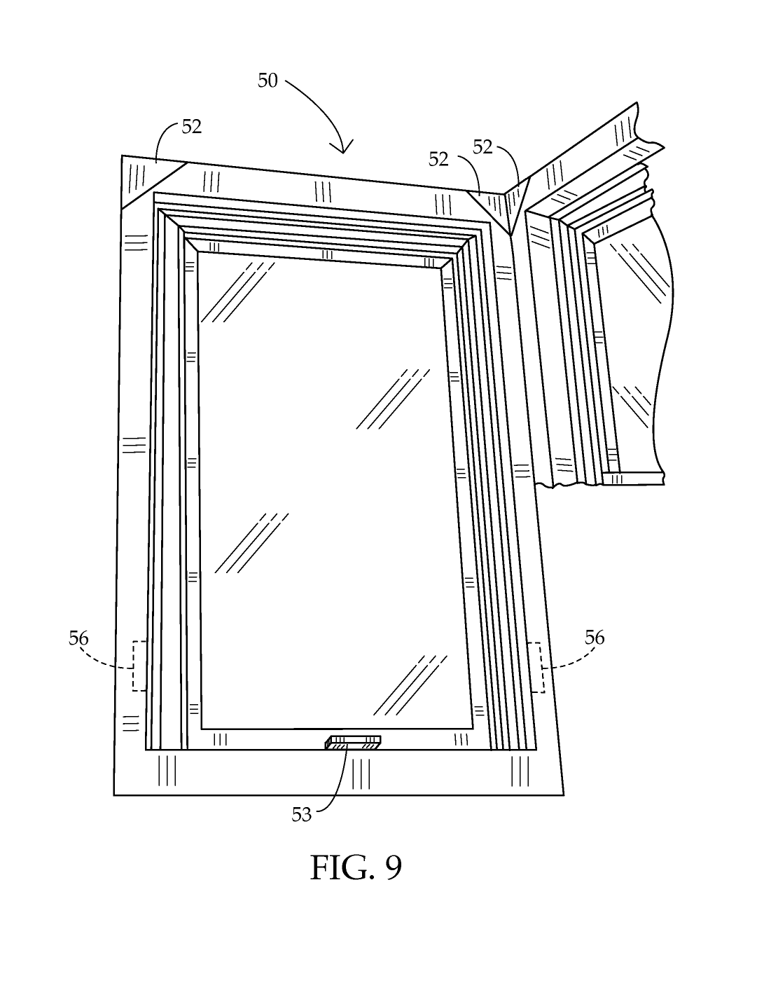

FIG. 9 depicts integrated window 50 wherein integrated securing device 52 is preferably formed as part of the underlying window structure, thereby presenting a unitary design. This embodiment preferably includes integrated ledge 53 along bottom perimeter, to receive panel 34 upon installation, similar to bracket 20 of the primary embodiment. Ledge 53 can be a variety of widths, ranging from the entire bottom perimeter of the window, to a small bracket-like feature, as shown in FIG. 9. Integrated ledge 53, like integrated securing device 52, is preferably formed as part of the underlying window structure, thereby presenting a unitary design.

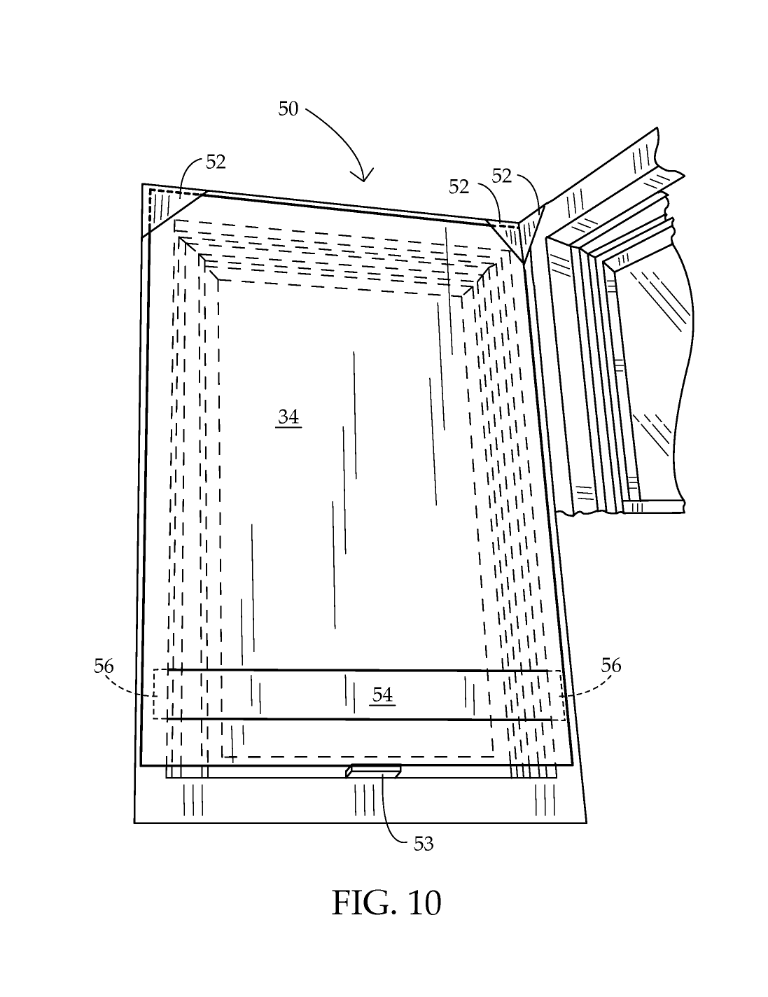

Integrated window 50 also includes a pair of opposing orifices 56 for receiving brace 54 (FIG. 10). In use, panel 34 is inserted upwardly into integrated securing devices 52, then lowered to rest on ledge 53. In this position, orifices 56 are frontward of panel 34, such that access to orifices 56 is not impeded. To further secure panel, brace 54 is inserted into orifices 56, as shown in FIG. 10.

Although not shown, one could further secure the assembly by securing brace 54 to panel 34, for example by screwing together. Said securing could be accomplished from the outside, which is to say that one would screw through brace 54 and continue screwing into panel 34. Alternatively, one could secure panel 34 to brace 54 from within the structure, by opening the window and screwing through panel 34 first, and continuing into brace 54. The latter method could be advantageous where it is undesirable to exit the building, and/or where it is desirable to eliminate outside access to screw heads.

Various modifications and features may be added to the system and method. For example, as shown in FIG. 8, it may be desirable to add handles 36 for ease of moving panel 34. Handles can be drawer pulls or the like, and are optionally hinged to allow folding in and out so to allow panels 34 to be stacked for storage. If handles are used, it is desirable to have exposed screw holes for ease of attachment. In addition, it may be useful to include marking 38 on panel so a user knows which specific panel fits on which specific opening. By way of example, going clockwise starting from the front entrance of a building, panels are sequentially numbered “1”, “2”, and so forth. Optionally, panel 34 may include a small plaque (approximately 4″×4″) either screwed or adhered to panel 34, having pre-printed numbers or for receiving marking 38. In addition, securing devices 10 and/or bracket 20 can be ornamental so they appear to be decorative window embellishments. Securing devices 10 and/or bracket 20 may be collected together in a kit, with each kit containing parts for one window (ie a pair of securing devices 10, pair of handles 36, one bracket 20 and associated screws), or for multiple windows, or any other desired combination. Securing devices 10 may secure all four corners of panel 34. Another possible modification or feature could be double securing devices which share a wall and permit the insertion of two corners of adjacent windows into adjacent hollow portions. In addition, it is possible to use the present inventions on bay windows, cathedral (circular or semi-circular) windows, possibly by positioning securing devices 10 below window, or even on curved windows by using bendable wood. Moreover, various parts, especially securing device 10 and bracket 20 should be paintable so as to aesthetically complement the building structure and protect invention from the elements.

It should be understood, of course, that the foregoing relates to exemplary embodiments of the invention and that modifications may be made without departing from the spirit and scope of the invention as set forth in the following claims. By way of example, it is also possible to use embodiments of the invention in the interior of a structure, either alone or in combination with exterior protective devices. It should also be understood that ranges of values set forth inherently include those values, as well as all increments between. As used herein, “semi-permanent”, for example “semi-permanently attaching”, shall mean the connection of parts that remain connected in regular use, but which can be disconnected without destroying one or both of the underlying connected parts. As used herein “fragile areas” shall refer to windows, doors, associated openings, as well as regions having structural vulnerabilities due to nondurable materials (for example artwork) or lack of integrity (for example rotten wood, or missing siding).

What is claimed is:

1. A system for protecting the opening of a building structure, said system including:
a. A pair of securing devices substantially permanently attached above the opening;
b. A panel having four corners and four edges, said panel engaged with said securing devices at the two upper corners; and
c. A bracket engaged with said panel along the bottom edge.

2. The system of claim 1 wherein said pair of securing devices include a substantially planar top surface and a substantially planar bottom surface, said top surface and said bottom surface each oriented substantially parallel one to another.

3. The system of claim 2 wherein said top surface and said bottom surface are each substantially triangular.

4. The system of claim 3 wherein said top surface has a greater area than said bottom surface.

5. The system of claim 2 wherein said top surface and said bottom surface are connected one to another by at least one perpendicular wall.

6. The system of claim 5 wherein said top surface, said bottom surface and at least one of said perpendicular walls defines a hollow region.

7. The system of claim 6 wherein said two upper corners are engaged with said hollow region.

8. An improved window including:
a. A unitary window frame including a pair of substantially triangular integrated securing devices positioned near the upper corners of said window frame;
b. A pair of opposing orifices defined by the lateral sides of said window frame; and
c. An integrated ledge near the bottom edge of said window frame.

9. The improved window of claim 8 further including a removable panel having four corners and four edges, said panel engageable with said integrated securing devices.

10. The improved window of claim 9 wherein said panel is engageable with said integrated ledge.

11. The improved window of claim 8 further including a removable brace, said brace elongated and including two ends.

12. The improved window of claim 11 wherein the two ends of said brace are each engageable with one of said opposing orifices.

13. A method of protecting a fragile area of a structure including the steps of:
a. Semi-permanently attaching a pair of securing devices to opposing upper corners adjacent a fragile area;
b. Semi-permanently attaching at least one bracket to the bottom edge adjacent a fragile area;
c. Inserting upper corners of a panel into said securing devices; and
d. Engaging bottom edge of said panel with said bracket.

14. The method of claim 13 further including the step of securing said panel to said securing devices.

15. The method of claim 13 further including the step of securing said panel to said bracket.

16. The method of claim 13 further including the step of semi-permanently attaching a handle to said panel.

17. The method of claim 13 further including the step of marking said panel to identify corresponding fragile area.
